(19) United States
(12) Patent Application Publication
(10) Pub. No.: US 2014/0257849 A1
(43) Pub. Date: Sep. 11, 2014

(54) PATIENT SUPPORT APPARATUS CONFIGURED FOR COMMUNICATING WITH IMPLANTABLE DEVICES

(71) Applicant: Hill-Rom Services, Inc., Batesville, IN (US)

(72) Inventor: Sandy M. RICHARDS, Pershing, IN (US)

(73) Assignee: Hill-Rom Services, Inc., Batesville, IN (US)

(21) Appl. No.: 14/196,341

(22) Filed: Mar. 4, 2014

Related U.S. Application Data
(60) Provisional application No. 61/774,193, filed on Mar. 7, 2013.

(51) Int. Cl. G06F 19/00

(52) U.S. Cl. CPC G06F 19/3418
USPC 705/3

(57) ABSTRACT

A method and apparatus for associating data from an implantable device with a patient support apparatus includes a controller of the patient support apparatus that is operable to act as a programmer for implantable devices. The controller is also in communication with a network which supports a hospital information system. The controller is operable to act on data or alerts from the implantable device to change operation of the patient support apparatus or communicate with the hospital information system

### CROSS-REFERENCE TO RELATED U.S. PATENT APPLICATION

This present application claims priority under 35 U.S.C. §119(e) to U.S. Provisional Patent Application Ser. No. 61/774,193, entitled “A PATIENT SUPPORT APPARATUS CONFIGURED FOR COMMUNICATING WITH IMPLANTABLE DEVICES,” which was filed on Mar. 7, 2013, the entirety of which is hereby incorporated by reference.

### BACKGROUND

The present disclosure relates to a patient support apparatus having a controller that is operable to act as a programmer for an implantable device. More specifically, the present disclosure is related to a patient support apparatus having controller that communicates with an implantable device and is operable to act on data received from the implantable device.

Implantable devices have become quite pervasive in modern medicine. Implantable devices may be as simple as a prosthetic such as a joint replacement or as complicated as a medication delivery system that responds to biometric data received by the device. In most cases, implantable devices include identification information that allows the particular device to be identified. In some cases, that identification information is available through wireless communications circuitry in the implantable device.

Patient support apparatuses such as hospital beds, for example, have become more sophisticated including the implantation of communications networks between various modules of the patient support apparatus. In a hospital setting, the identification and location of a particular patient is often associated with a particular patient support apparatus. Patient support apparatuses may include a unique identifier which identifies the particular patient support apparatus to external systems such as a hospital information system, for example. It is important that the appropriate patient be associated patient support apparatus so that the hospital information system can track the patient and maintain the patent's electronic medical record.

### SUMMARY

The present application discloses one or more of the features recited in the appended claims and/or the following features which, alone or in any combination, may comprise patentable subject matter:

According to a first aspect of the present disclosure, a method for transferring medical data from an implantable medical device to a health information system using a patient support apparatus comprises receiving medical data from the implantable medical device, determining an identity of the implantable medical device, associating the received medical data with the patient support apparatus, and transmitting the received medical data and the data identifying the associated patient support apparatus to the health information system. Receiving the medical data from the implantable medical device includes receiving the data with the patient support apparatus. Determining an identity of implantable medical device includes determining the identity on the patient support apparatus. Determining the nature of the received medical data includes determining with the patient support apparatus. The received medical data and data identifying the assisted patient support apparatus to the health information system is transmitted from the patient support apparatus in response to determining the nature of the received medical data.

In some embodiments, receiving the medical data comprises receiving the medical data from wireless communication circuitry.

In some embodiments, receiving the medical data from the implantable medical device is in response to establishing a wireless communication connection between the patient support apparatus and the implantable medical device.

In some embodiments, receiving the medical data is in response to transmitting, from the patient support apparatus, a request for the medical data.

In some embodiments, determining the identity of the implantable medical device comprises performing, on the patient support apparatus, a handshaking protocol with the implantable medical device. In some embodiments, performing the handshaking protocol comprises receiving, with the patient support apparatus, a unique identifier of the implantable medical device from the implantable medical device.

In some embodiments, determining the nature of the received medical data comprises receiving identifying information associated with the medical data from the implantable medical device.

In some embodiments, transmitting the received medical data and the data identifying the associated patient support apparatus comprises transmitting an alert message to the hospital information system. In some embodiments, transmitting the alert message comprises transmitting an alert message to a nurse's station using a nurse call cable. In some embodiments, transmitting the alert message comprises wirelessly transmitting the alert message.

In some embodiments, the method further comprises analyzing, on the patient support apparatus, the received medical data to determine whether a health condition is met, the health condition and associated medical data criteria having been pre-established on the patient support apparatus.

In some embodiments, the method further comprises performing a function using the patient support apparatus in response to the received medical data satisfying the health condition.

In some embodiments, performing the function comprises at least one of: automatically performing a mechanical function and transmitting an alert to the hospital information system.

In some embodiments, the method further comprises transmitting, from the patient support apparatus to the implantable medical device, instructions to update the implantable medical device in response to receiving the instructions from the hospital information system.

In another aspect of the present disclosure, a controller of a patient support apparatus comprises a processor and a memory. The memory stores a plurality of instructions. When executed by the processor, some instructions cause the controller to receive medical data from an implantable medical device. When executed by the processor, some instructions cause the controller to determine an identity of the implantable medical device. When executed by the processor, some instructions cause the controller to determine a nature of the received medical data. When executed by the processor, some instructions cause the controller to associate the received medical data with the patient support apparatus. When executed by the processor, some instructions cause the controller to transmit the received medical data to a health information system.

In some embodiments, the implantable medical device comprises wireless communication circuitry.

In some embodiments, the plurality of instructions cause the controller to receive the medical data from the implantable medical device in response to establishing a wireless communication connection between the patient support apparatus and the implantable medical device.

In some embodiments, the plurality of instructions cause the controller to receive the medical data in response to a request for the medical data from the patient support apparatus.

In some embodiments, the plurality of instructions cause the controller to determine the identity of the implantable medical device by performing a handshaking protocol with the implantable medical device.

In some embodiments, the handshaking protocol comprises a transmission of a unique identifier of the implantable medical device from the implantable medical device to the controller.

In some embodiments, the plurality of instructions cause the controller to determine the nature of the received medical data by receiving identifying information associated with the medical data from the implantable medical device.

In some embodiments, the received medical data comprises an alert message.

In some embodiments, the plurality of instructions cause the controller to transmit the alert message to a nurse's station using a nurse call cable.

In some embodiments, the plurality of instructions cause the controller to wirelessly transmit the alert message.

In some embodiments, the plurality of instructions cause the controller further to analyze the received medical data to determine whether a pre-established health condition is met. In some embodiments, the plurality of instructions cause the patient support apparatus to perform a function in response to the received medical data satisfying the pre-established health condition. In some embodiments, the function comprises at least one of: a mechanical operation and transmitting an alert to the hospital information system.

In some embodiments, the plurality of instructions cause the controller further to transmit to the implantable medical device instructions to update the implantable medical device in response to receiving the instructions from the hospital information system.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is diagrammatic representation of the structure of a patient support apparatus that is connected to a network in a hospital and in communication with an implantable device through wireless connection;

FIG. 2 is the portion of a flowchart describing an operational process of a controller of the patient support apparatus of FIG. 1;

FIG. 3 is the remaining portion of the flowchart of FIG. 2;

FIG. 4 is a flowchart representation of a subroutine of the operational process of FIGS. 2 and 3 describing how data received from an implantable device is identified by the controller;

FIG. 5 is a flowchart representation of a subroutine of the operational process of FIGS. 2 and 3 describing how data is analyzed to determine if a pre-determined condition established in the controller is met by the implantable device; and

FIG. 6 is a flowchart representation of a subroutine of the operational process of FIGS. 2 and 3 describing how data from the implantable device is associated with the patient support apparatus.

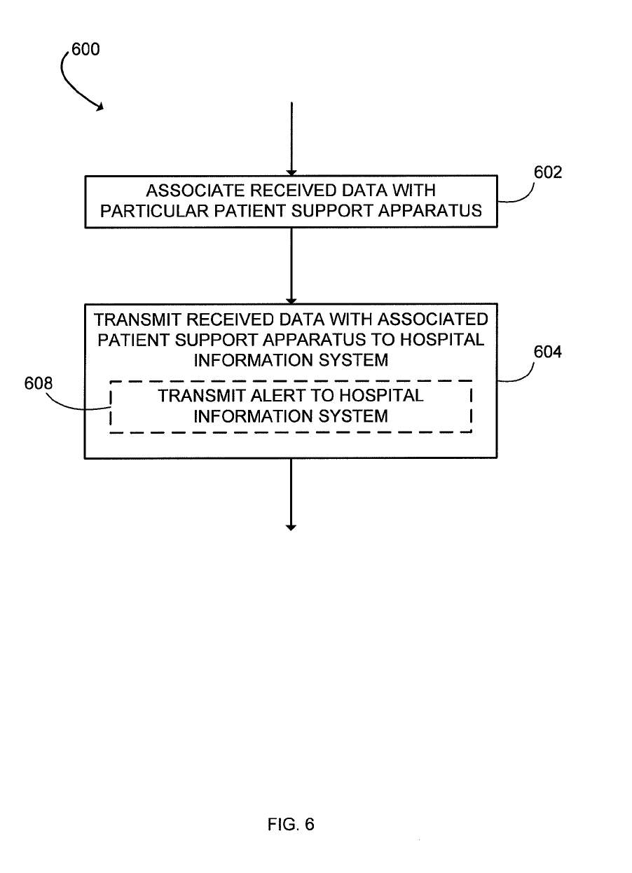

### DETAILED DESCRIPTION OF THE DRAWINGS

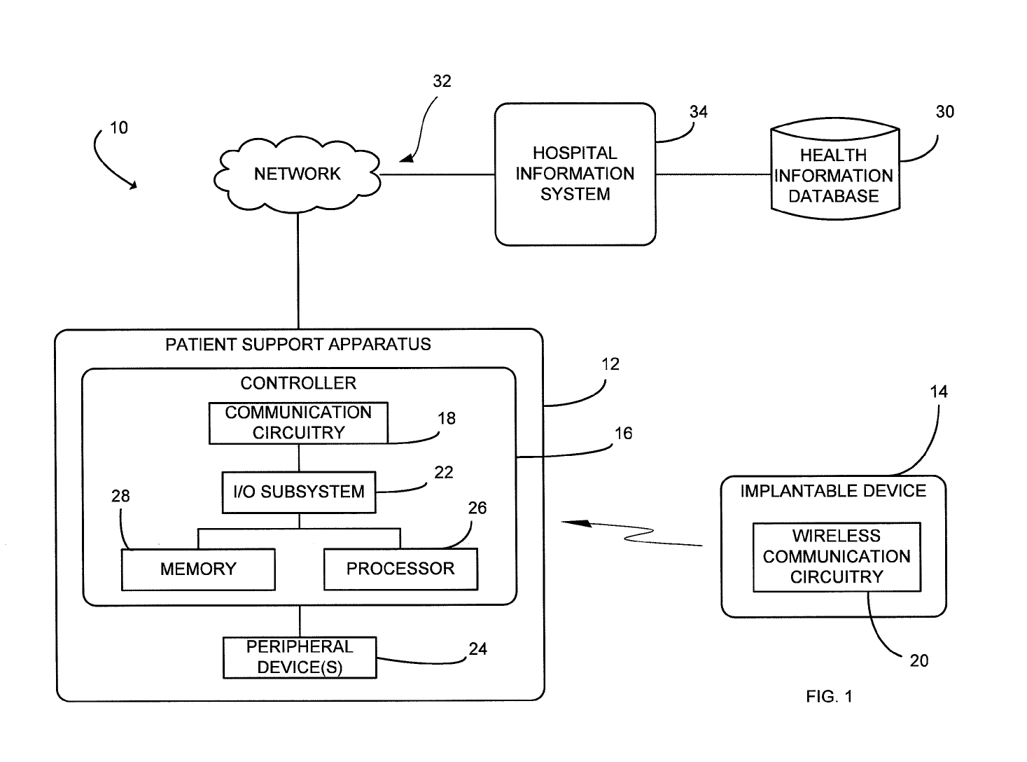

A system 10 for gathering information from an implantable device 14 and transferring the information to a health information database 30 includes a patient support apparatus 12 that has communication circuitry 18 that is operable to communicate with communication circuitry 20 of the implantable device 14 as suggested by FIG. 1. The implantable device 14 may be any of a number of active implantable devices such as pacemakers, cochlear implants, cardiac defibrillators, insulin pumps, neurostimulators or other sensors and therapeutic devices. In some embodiments, the implantable device 14 may be a passive device such as a prosthetic joint, a passive medication delivery system, or a simple radio frequency identification device. Utilizing the close proximity of the implantable device 14 to the patient support apparatus 12, the identity of the person in whom the implantable device 14 is implanted allows the association of the person with the patient support apparatus 12. Based on this association, the data from the implantable device 14 is transmitted by the patient support apparatus 12 to a network 32 that couples the patient support apparatus 12 to a hospital information system 34, utilizing the information about the person to associate the data with the person's specific electronic medical record. In other embodiments, the network 32 may be coupled to a traditional nurse call system.

The implantable device 14 includes the wireless communication circuitry 20 which is well known in the art. The United States Federal Communications Commission has set aside a 402-405 MHz band for medical implant communication services. Older implants may operate in the 175 kHz band. The medical implant communication services band is split into multiple channels of 300 kHz width. In order to preserve power, implantable devices that utilize wireless communication circuitry typically do not broadcast information unless prompted by a programmer device. The programmer device initiates the communication session with the implantable device 14 to request specific information or to modify the operation of the implantable device 14. In general, implantable devices only independently transmit information or alerts under certain extreme health conditions, such as a life-threatening condition, for example, or if there is a device malfunction. The standard operating procedure for communication between an implantable device, such as implantable device 14, and a programmer involves both devices listening to a particular 300 kHz channel for a period of time, such as 10 ms, to ensure that the channel is not being used by another device. Upon detection of an unoccupied channel, a communication session is established between the programmer and the implantable device 14 until the session ends or, in some cases, until the session encounters excessive interference. If excessive interference is encountered, the programmer and implantable device 14 move to another channel and listen to determine if the channel can be used.

The patient support apparatus 12 includes a controller 16 which includes the communication circuitry 18 that acts as a programmer to the implantable device 14. The controller 16 also includes an I/O subsystem 22 coupled to the communication circuitry 18 as well as a processor 26 and a memory device 28. The processor 26 is operable to use instructions stored in memory 28 to operate the I/O subsystem 22 which controls communication circuitry 18 as well as communication with the network 32. The controller 16 is in communication with peripheral devices of the patient support apparatus, such as peripheral device 24 shown in FIG. 1. Peripheral device 24 may be any of a number of subsystems of a patient support apparatus known in the art. For example if patient support apparatus 12 is embodied as a hospital bed, peripheral device 24 may include any one of a scale system, side rail position monitoring system, a brake mechanism monitoring system, a bed position monitoring system, a patient position monitoring system including bed exit detection capability, or a therapy device such as a therapeutic mattress, for example. In general, peripheral device 24 may be embodied as any subsystem or device that monitors a patient condition, monitors and operating condition of the patient support apparatus, controls and operating condition of the patient support apparatus, or provides therapy to patient supported on the patient support apparatus 12.

It is contemplated that the controller 16 may be programmed to operate as a universal programmer capable of communicating with any of a number of different types and brands of implantable devices. During normal operation, controller 16 will regularly attempt to initiate communication with an implantable device such that any implantable device within the operating range of the communication circuitry 18 of the controller 16 may be detected and engaged by the controller 16.

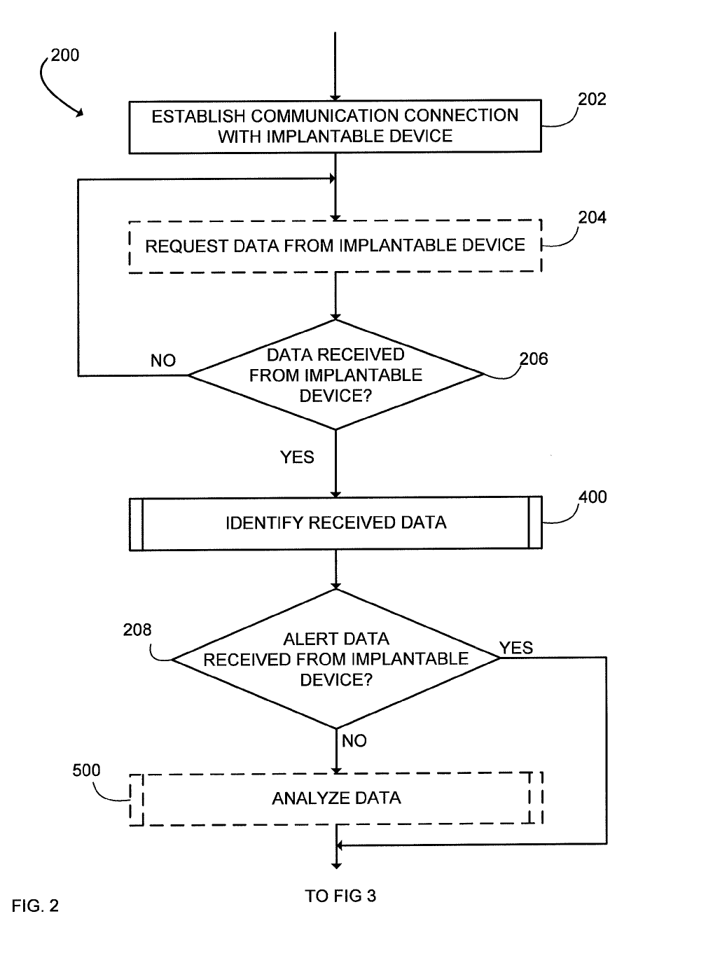

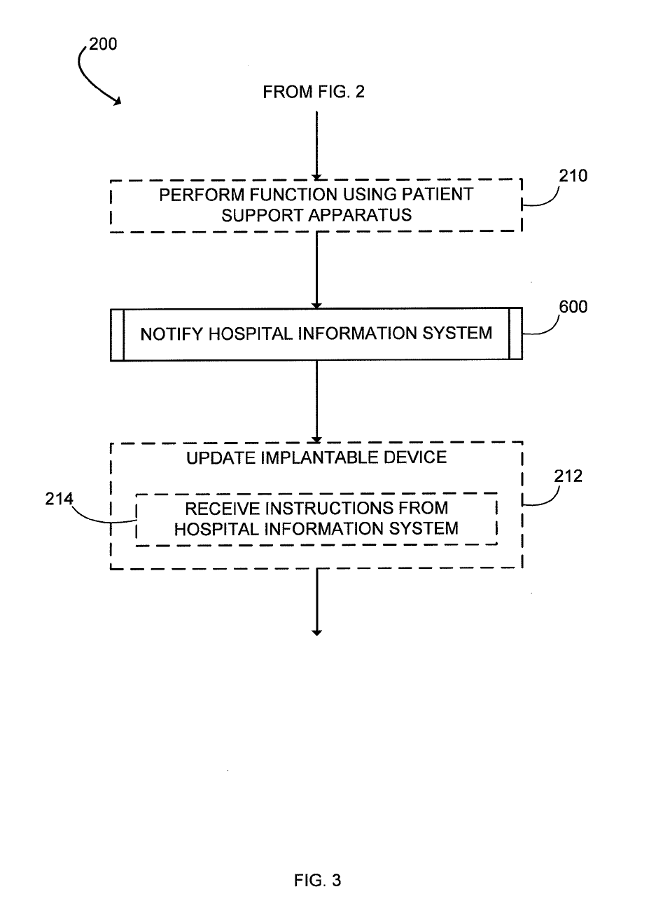

A process 200 shown in FIGS. 2-3 provides an overview of the various actions the controller 16 may take in relation to the implantable device 14. Process steps shown in phantom indicate that the particular process step is optional as will be discussed in further detail below. At the initial process step 202 the controller 16 establishes a communication connection with the implantable device 14 with the communication circuitry 18 of controller 16 operating to initiate communications with the wireless communication circuitry 20 of the implantable device 14.

Process 200 proceeds to optional process step 204 where the controller 16 requests data from the implantable device 14. While process step 204 is optional, is contemplated that in most applications controller 16 will at least request sufficient data from the implantable device 14 to establish the identity of the person in whom the implantable device 14 is implanted. Other data may be also requested from the implantable device 14, such as operating conditions, battery charge level, a device serial number, or other general information. It is contemplated that the request for data from the implantable device 14 will be intermittent to limit the power consumption of the implantable device 14.

Process 200 proceeds to decision step 206 where the controller 16 evaluates whether data has been received from the implantable device 14. Received data may be in response to a request made at process step 204, or may be data independently transmitted by the implantable device 14, such as an emergency condition, for example. If no data has been received, process 200 returns and continues to monitor for received data. If data is received from the implantable device 14, process 200 proceeds to a subroutine 400 that is used to identify the received data. Subroutine 400 will be discussed in further detail below.

Process 200 then proceeds to decision step 208 to determine whether alert data has been received from the implantable device 14. Alert data include information identifying and unacceptable condition as determined by the implantable device 14. An unacceptable condition may include a malfunction of the implantable device 14 or a negative physiological condition of the patient as detected by the implantable device 14. For example, if the inflatable device 14 is a cardiac defibrillator, a defibrillation event would generate an alert that would be transmitted to the controller 16. Other alert conditions may include a low battery level in the implantable device 14, a low level of insulin if the implantable devices and insulin pump, or any other condition which may require intervention.

If no alert data is received from the implantable device 14, then process 200 proceeds to subroutine 500 in which the data that is provided is analyzed by the controller 16 as will be discussed in further detail below. It should be understood that an output of subroutine 500 may include analysis of non-alert data that when analyzed indicates an intervention is required, even though no alert data has yet been received.

Process 200 proceeds to optional process step 210 in which the controller 16 may change an operating parameter of the patient support apparatus 10. This may include the modification of the operation of any peripheral device 24. For example, if data received from the implantable device 14 indicates that a patient is in cardiac arrest or respiratory distress, controller 16 may automatically move one or more patient support apparatus member to a position which assists a caregiver in intervening with the patient. In the case of cardiac arrest, controller 16 may move the bed to a CPR position in anticipation of a caregiver having to perform CPR on the patient. If data from the implantable device 14 indicates that the patient is in respiratory distress, for example, controller 16 may move a member of the patient support apparatus 12 to position which increases the angle of incline of the patient's upper body so that the patient is better able to breathe. In still another example, if the implantable device 14 is operable to detect a patient's blood pressure, and blood pressure is determined to be low, controller 16 may move the patient support apparatus members such that the patient's legs are elevated. If the peripheral device 24 is a therapeutic mattress, controller 16 may change the operation of the therapeutic mattress, for example, to increase a relative level of pulmonary therapy.

Process 200 then proceeds to subroutine 600 were the controller 16 is operable to notify the hospital information system 34 of information related to the implantable device 14. As will be discussed in further detail below the subroutine 600 is operable to associate information regarding the implantable device 14 with the person in whom the implantable device 14 is implanted and the patient support apparatus 12 so that the information may be properly placed in the health information database 30 and associated with the particular persons electronic medical record.

Once the hospital information system 30 has been notified, process 200 proceeds to an optional process step 212 in which the implantable device 14 is updated with information or the operation of the implantable device 14 is modified. A sub-process step 214 occurs when the controller 16 receives instructions from the hospital information system 34 over the network 32. In this case, the controller 16 may modify the operation of the patient support apparatus 12, including modifying the operation of a peripheral device 24, or may also utilize communication circuitry 18 to communicate new instructions to the implantable device 14 via the wireless communication circuitry 20. While the optional process step 212 is positioned as the last step in the process 200, it should be understood that optional process step 212 could occur anytime during the operation of the controller 16. For example, the hospital information system 34 may receive an order from a physician that results in the need to change an operating parameter of the implantable device 14. Once the association of the implantable device 14, patient support apparatus 12 and person have been completed, hospital information system 34 may utilize that association to communicate data to the implantable device 14 through the network 32 and patient support apparatus 12.

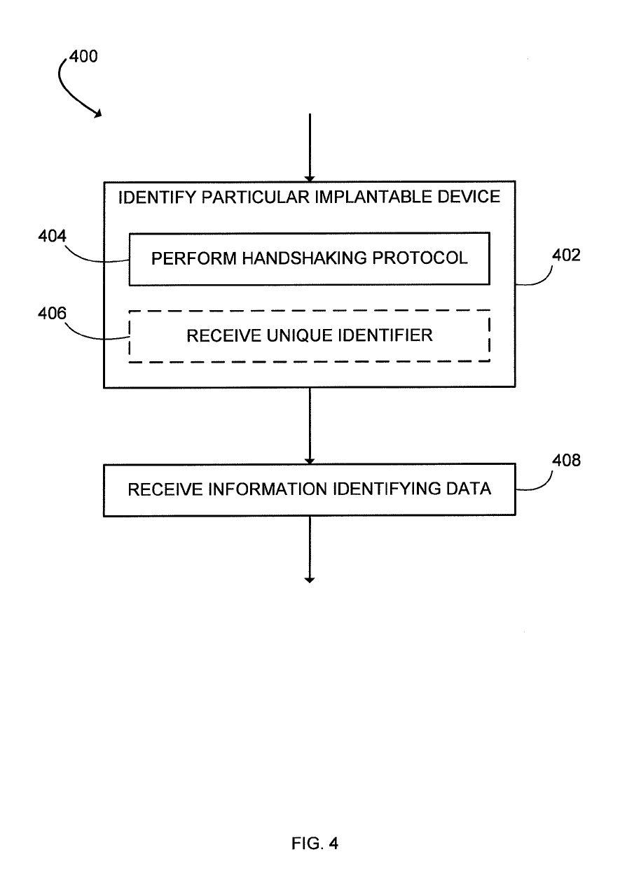

Referring now to FIG. 4, subroutine 400 includes a first process step 402 in which the controller 16 is operable to identify the implantable device 14 as a particular implantable device. A sub-process step 404 is a handshaking protocol that is used to confirm the compatibility of the controller 16 as a programmer of the implantable device 14. In identifying the particular implantable device 14, the controller 16 may optionally receive a unique identifier from the implantable device 14 as indicated by optional process step 406. Once the relationship between the particular implantable device 14 and the controller 16 is established, the controller 16 receives identifying data from the particular implantable device 14. This data may include an explicit patient identification number or other information that associates the implantable device 14 with a particular patient. As noted above, once subroutine 400 is completed process 200 continues to the decision step 208 discussed above.

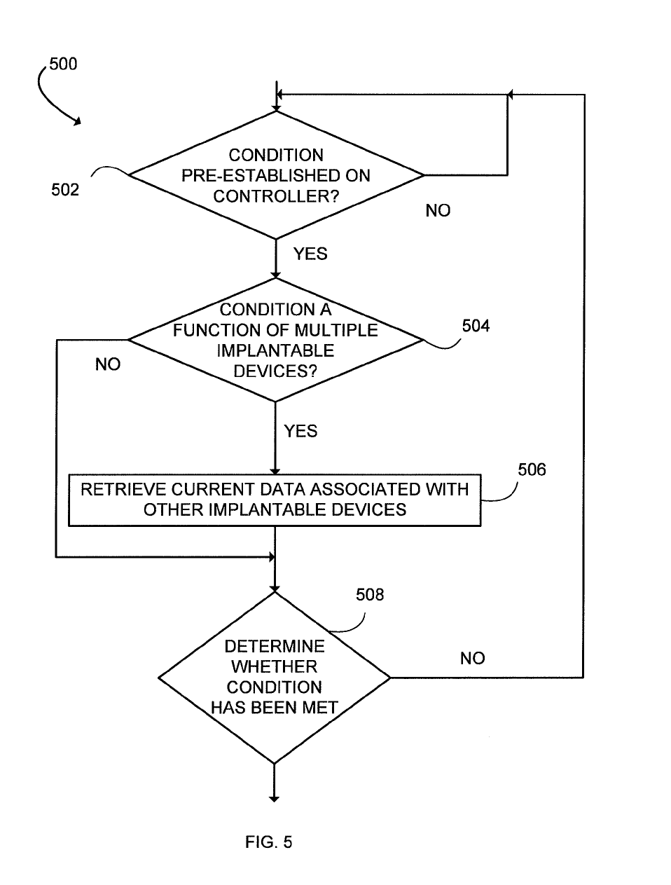

As discussed above, if no alert data is received from the implantable device 14 as determined at decision step 208, subroutine 500, shown in FIG. 5, includes a first decision step 502 where it is determined if a condition is pre-established on the controller 16 that is related to data from the particular implantable device 14. If no such condition is pre-established on the controller 16, then the subroutine 500 loops back and continues to monitor for data from an implantable device that does have a condition that is pre-established on the controller 16. If it is determined that a health condition or device malfunction condition that is pre-established on controller 16 does relate to data from the particular implantable device 14, subroutine 500 proceeds to decision step 504 where the condition is further evaluated to determine if it is a function of a single implantable device, or of multiple implantable devices. If it is determined at decision step 504 that the condition is dependent on only the particular implantable device 14, subroutine 500 progresses to decision step 508 to determine whether the condition has been met. If the condition has not been met, then subroutine 500 loops back and continues to monitor for relevant data. If the condition has been met as evaluated at decision step 508, then process 200 proceeds to either optional process step 210 or subroutine 600 as described above.

If at decision step 504 for it is determined that the condition is a function of multiple implantable devices, then subroutine 500 proceeds to process step 506 where data from other implantable devices or peripheral devices 24 is retrieved so that all of the data from each of the relevant devices may be evaluated to determine whether a condition has been met at decision step 508. Such a situation may exist when, for example, data from an implantable blood pressure monitor is compared to data from a cardiac defibrillator and the combined conditions of the two indicate an unsafe condition or a level of distress in the patient that may not be identified by either device independently. In some embodiments, the information from the implantable device 14 may be compared to information from one of the peripheral devices 24 to determine if a particular condition has been met. For example, a peripheral device 24 may be a traditional blood pressure monitor and an implantable device 14 may be a cardiac defibrillator and the condition may involve evaluating data from both the blood pressure monitor and a cardiac defibrillator to determine whether the condition has been met.

When subroutine 600 is invoked, the data from the implantable device 14 is associated with a unique identifier for the particular patient support apparatus 12. A unique identifier for the patient support apparatus 12 is maintained in memory 28 and is associated with data from the implantable device 14 using methods known in the art. Subroutine 600 then proceeds to process step 604 where the associated data is transmitted to the hospital information system 34 over the network 32 to be stored in the health information database 30. Process step 604 includes an optional process step 608 that includes transmitting alert information to the hospital information system 34 if an alert condition is generated by the implantable device 14. If the condition has been determined to be met in subroutine 500, that information may also be transferred over the network 32 to the hospital information system 34. In other embodiments, the I/O subsystem 22 may also transmit the alert condition to a nurse's station over a traditional nurse call cable.

Information may be transferred over the network 32 to the hospital information system 34 by the controller 16 in real time, or may be stored in memory 28 and transferred to the network 32 on an intermittent basis. In still other embodiments, when the information is stored on the controller 16, the hospital information system 34 may be operable to query the controller 16 to receive the most recent information stored by controller 16 in memory 28. Controller 16 may combine and associate information from peripheral devices 24 as well as implantable device 14 so that all of the information may be transferred to the hospital information system 34 as a single record.

It should be understood that the network 32 may be connected to the patient support apparatus 12 through a wired data link, or the network connection may be a wireless data link.

Although certain illustrative embodiments have been described in detail above, variations and modifications exist within the scope and spirit of this disclosure as described and as defined in the following claims.

1. A method for transferring medical data from an implantable medical device to a health information system using a patient support apparatus, the method comprising:
receiving, with the patient support apparatus, the medical data from the implantable medical device;
determining, on the patient support apparatus, an identity of the implantable medical device;
determining, with the patient support apparatus, a nature of the received medical data;
associating the received medical data with the patient support apparatus; and
transmitting, from the patient support apparatus, the received medical data and data identifying the associated patient support apparatus to the health information system in response to determining the nature of the received medical data.

2. The method of claim 1, wherein receiving the medical data comprises receiving the medical data from wireless communication circuitry.

3. The method of claim 1, wherein receiving the medical data from the implantable medical device is in response to establishing a wireless communication connection between the patient support apparatus and the implantable medical device.

4. The method of claim 1, wherein receiving the medical data is in response to transmitting, from the patient support apparatus, a request for the medical data.

5. The method of claim 1, wherein determining the identity of the implantable medical device comprises performing, on the patient support apparatus, a handshaking protocol with the implantable medical device.

6. The method of claim 5, wherein performing the handshaking protocol comprises receiving, with the patient support apparatus, a unique identifier of the implantable medical device from the implantable medical device.

7. The method of claim 1, wherein determining the nature of the received medical data comprises receiving identifying information associated with the medical data from the implantable medical device.

8. The method of claim 1, wherein transmitting the received medical data and the data identifying the associated patient support apparatus comprises transmitting an alert message to the hospital information system.

9. The method of claim 8, wherein transmitting the alert message comprises transmitting an alert message to a nurse's station using a nurse call cable.

10. The method of claim 8, wherein transmitting the alert message comprises wirelessly transmitting the alert message.

11. The method of claim 1, further comprising analyzing, on the patient support apparatus, the received medical data to determine whether a health condition is met, the health condition and associated medical data criteria having been pre-established on the patient support apparatus.

12. The method of claim 11, further comprising performing a function using the patient support apparatus in response to the received medical data satisfying the health condition.

13. The method of claim 12, wherein performing the function comprises at least one of: automatically performing a mechanical function and transmitting an alarm to the hospital information system.

14. The method of claim 1, further comprising transmitting, from the patient support apparatus to the implantable medical device, instructions to update the implantable medical device in response to receiving the instructions from the hospital information system.

15. A controller of a patient support apparatus comprising:
a processor; and
a memory having stored therein a plurality of instructions that when executed by the processor cause the controller to:
receive medical data from an implantable medical device;
determine an identity of the implantable medical device;
determine a nature of the received medical data;
associate the received medical data with the patient support apparatus; and
transmit the received medical data to a health information system.

16. The controller of claim 15, wherein the implantable medical device comprises wireless communication circuitry.

17. The controller of claim 15, wherein the plurality of instructions cause the controller to receive the medical data from the implantable medical device in response to establishing a wireless communication connection between the patient support apparatus and the implantable medical device.

18. The controller of claim 15, wherein the plurality of instructions cause the controller to receive the medical data in response to a request for the medical data from the patient support apparatus.

19. The controller of claim 15, wherein the plurality of instructions cause the controller to determine the identity of the implantable medical device by performing a handshaking protocol with the implantable medical device.

20. The controller of claim 19, wherein the handshaking protocol comprises a transmission of a unique identifier of the implantable medical device from the implantable medical device to the controller.
